(19) United States
(12) Patent Application Publication
(10) Pub. No.: US 2025/0028791 A1
(43) Pub. Date: Jan. 23, 2025

(54) BLOCKCHAIN-BASED LICENSING AS A SERVICE

(71) Applicant: VMware, Inc., Palo Alto, CA (US)

(72) Inventors: Bo LIN, Beijing (CN); Qi WU, Beijing (CN); Xi ZENG, Beijing (CN); Kai LOU, Beijing (CN); Dongping CHEN, Beijing (CN); Yi ZENG, Beijing (CN); Danyang LI, Beijing (CN); DongSheng SHEN, Beijing (CN); Donghai HAN, Beijing (CN)

(73) Assignee: VMware, Inc., Palo Alto, CA (US)

(21) Appl. No.: 18/239,766

(22) Filed: Aug. 30, 2023

(30) Foreign Application Priority Data
Jul. 17, 2023 (WO) PCT/CN2023/107676

(51) Int. Cl. G06F 21/10; H04L 9/00

(52) U.S. Cl. CPC G06F 21/105; H04L 9/50

(57) ABSTRACT

Example methods and systems for blockchain-based licensing as a service are described. In one example, a computer system may receive a first request to obtain a first license associated with a first product from a first client system. In response, the computer system may (a) select a first blockchain from multiple blockchains, and (b) generate and store a first non-fungible token (NFT) on the first blockchain to issue the first license. Further, the computer system may receive a second request to obtain a second license associated with the first product or a second product from a second client system. In response, the computer system may (a) select a second blockchain from multiple blockchains, and (b) generate and store a second NFT on the second blockchain to issue the second license.

### CROSS-REFERENCE TO RELATED APPLICATION

The present application claims the benefit of Patent Cooperation Treaty (PCT) Application No. PCT/CN2023/107676, filed Jul. 17, 2023. The aforementioned PCT application is incorporated herein by reference in its entirety.

### BACKGROUND

Traditionally, one approach for product licensing (e.g., software products) is to have a written agreement between a licensor and a customer (i.e., licensee). However, this approach often lacks scalability and efficiency. Also, it may be challenging for the licensor to ensure that the customer is complying with the terms and agreements of the contract. More recently, licensing as a service (LaaS) has been implemented to address various limitations of conventional licensing approaches. For example, a LaaS provider may provide an online solution for licensors to license their products, such as software as a service (SaaS) companies, etc. However, some licensors may not be satisfied with the trust and security features of existing LaaS solutions. In some cases, these licensors may prefer to develop their own in-house solutions and/or run a self-hosted license server, regardless of the extra costs involved.

### BRIEF DESCRIPTION OF DRAWINGS

FIG. 1 is a schematic diagram illustrating an example system architecture for blockchain-based licensing as a service;

FIG. 2 is a flowchart of an example process for a computer system to perform blockchain-based licensing as a service;

FIG. 3 is a schematic diagram illustrating an example of blockchain-based licensing as a service using multiple blockchains;

FIG. 4 is a schematic diagram illustrating an example license store registration by licensor(s) or vendor(s);

FIG. 5 is a diagram illustrating an example smart contract implementation for registering a license store and placing license type tokens on the license store;

FIG. 6 is a diagram illustrating example token minting functions for blockchain-based licensing as a service;

FIG. 7 is a schematic diagram illustrating an example license acquisition by licensees from a licensor or vendor;

FIG. 8 is a diagram illustrating an example smart contract implementation for purchasing a license listed on a license store;

FIG. 9 is a schematic diagram illustrating an example license acquisition by a vendor from a licensor;

FIG. 10 is a schematic diagram illustrating an example Merkle tree for blockchain-based licensing as a service; and

FIG. 11 is a schematic diagram illustrating an example software-defined networking (SDN) environment for which blockchain-based licensing as a service may be implemented.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein. Although the terms “first” and “second” are used to describe various elements, these elements should not be limited by these terms. These terms are used to distinguish one element from another. For example, a first element may be referred to as a second element, and vice versa.

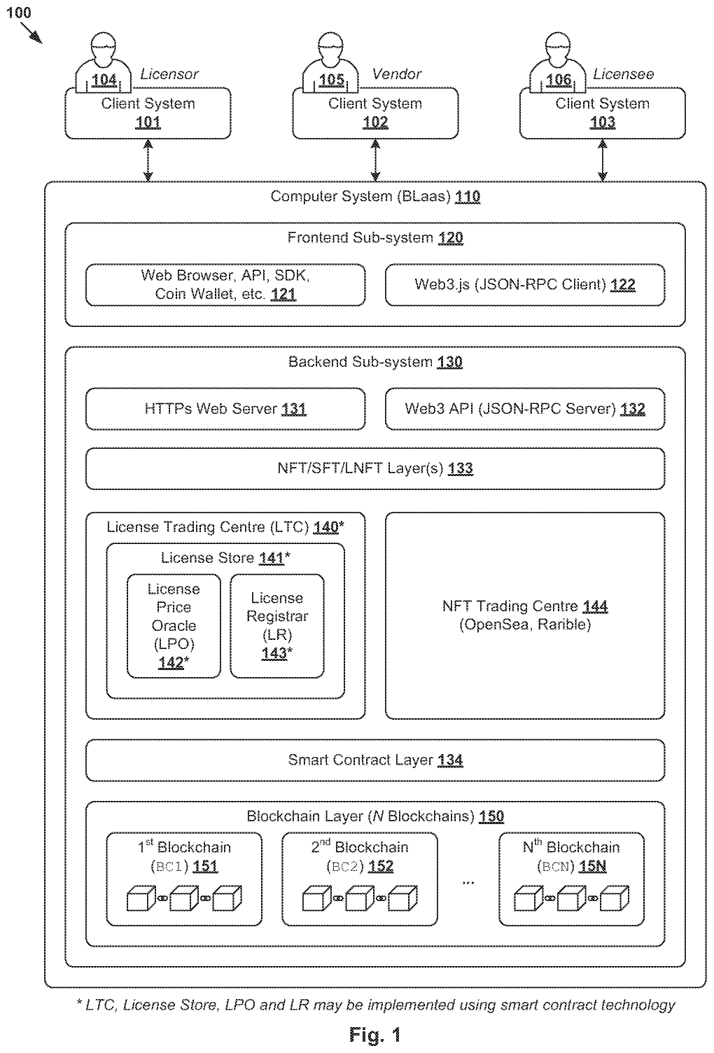

According to examples of the present disclosure, blockchain-based licensing as a service (referred to as “BLaaS” below) may be implemented to improve various technical feature(s) relating to licensing, such as to improve trust and security by leveraging blockchain (and related) technologies. In one example, a computer system (e.g., BLaaS system 110 in FIG. 1) may receive a first request to obtain a first license associated with a first product from a first client system. In response, the computer system may select a first blockchain from multiple blockchains accessible by the computer system. The selection may be based on first feature(s) associated with the first blockchain (e.g., BC1 151 in FIG. 1). Next, the computer system may generate and store a first non-fungible token (NFT) on the first blockchain to issue the first license, such as based on a first fungible token (FT) associated with the first product.

Further, the computer system may receive a second request to obtain a second license associated with the first product or a second product from a second client system. In response, the computer system may select a second blockchain from the multiple blockchains. The selection may be based on second feature(s) associated with the second blockchain (e.g., BC2 152 in FIG. 1). Next, the computer system may generate and store a second NFT on the second blockchain to issue the second license, such as based on the first FT associated with the first product or a second FT associated with the second product.

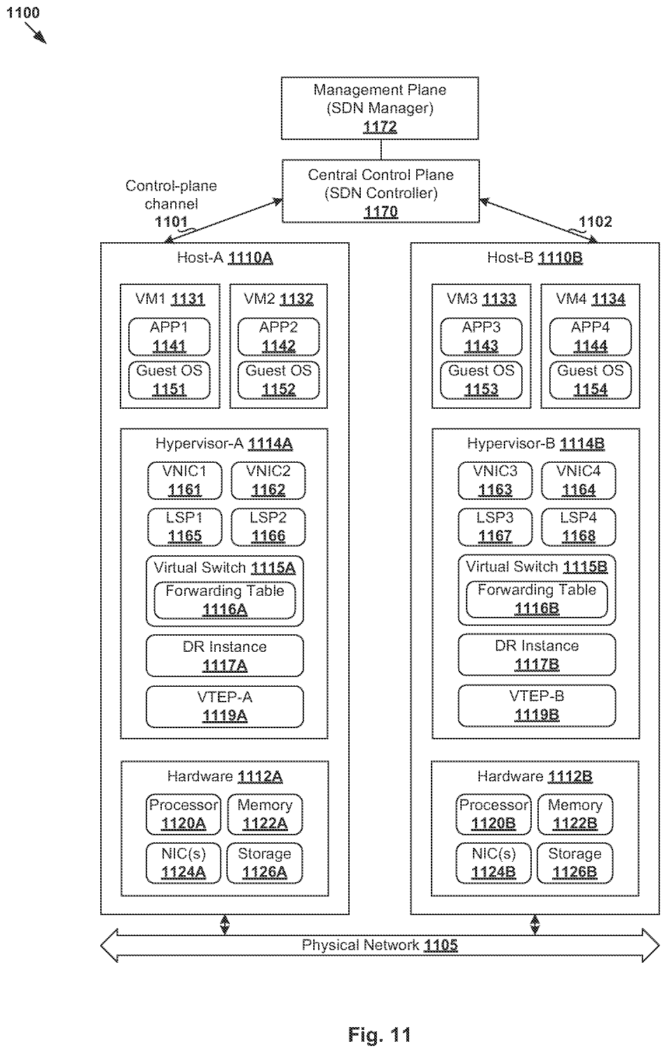

Depending on the desired implementation, examples of the present disclosure may be implemented to implement LaaS for software products, such as software for managing a software-defined networking (SDN) environment to be discussed using FIG. 11, etc. The term “license” may refer generally to an agreement between two parties where a first party (i.e., licensor) grants a permission to a second party (i.e., licensee) to use something, such as product(s) and/or service(s) provided by the first party. A “product” may be in physical and/or digital form.

### Example System Architecture

FIG. 1 is a schematic diagram illustrating an example system architecture 100 for blockchain-based licensing as a service (BLaaS). Here, system architecture 100 may include licensing service system 110 capable of interacting client systems 101-103 operated by various user types 104-106. Licensing service system 110 (also referred to as BLaaS system) may include frontend sub-system 120 and backend sub-system 130 to be described further below.

### (a) Client Systems

First client system 101 may be operated by user=licensor 104, who may be a product owner or provider responsible for a licensing service declared in a license agreement. Licensor 104 may be a license provider capable of defining metadata for licensing type including product information, permission scope, license agreement and validity period.

Second client system 102 may be operated by user=vendor 105, who may be a product distributor responsible for selling licenses on behalf of licensor 104. In practice, some manufacturers or service providers may prefer to outsource to distributors who are capable of selling their products and providing after-sales services.

Third client system 103 may be operated by user=licensee 106, who may be a customer purchasing a license to acquire a product or service from licensor 104 directly, or via vendor 105 indirectly. Client system 101/102/103 may be any suitable computer system(s) capable of interacting with BLaaS system 110, such as phone, computer laptop, tablet, etc.

### (b) Frontend Sub-System

Frontend sub-system 120 may be configured to provide easy interoperability to users 104-106 using any suitable technology (see 121) relating to web user interface (UI), application programming interface (API), software development kit (SDK), wallet plugin, etc. Frontend sub-system 120 may include client 122, such as a JavaScript Object Notation remote procedure call (JSON-RPC) client. The use of blockchain technologies may be transparent to users 104-106 in backend sub-system 130. Software and decentralized application (DApp) developers may provide service support by integrating with data analysis, license validation and licensing support proxy via API and SDK, etc.

### (c) Backend Sub-System

Backend sub-system 130 may be implemented based on micro-service design architecture for scalability and availability. For example, backend sub-system 130 may include hypertext transfer protocol secure (HTTPS) web server 131 and Web3 API server 132 to support both traditional HTTPs service and Web3 service. HTTPS web server 131 may be used for non-sensitive data storing/querying, and in some cases may cache data in blockchain for performance reasons. HTTPs server 131 may provide user-friendly interfaces to present licensing service blockchain data, store some non-blockchain data (e.g., user profile data, license description) and offer personal licensing smart contract. HTTPs web server 131 may support a variety of licensing modes. Web3 API server 132 (e.g., JSON-RPC server) may represent a blockchain provider node to offer web API for accessing blockchain(s). JSON-RPC client 122 and HTTPS web server 131 may access blockchain data via Web3 API server 132.

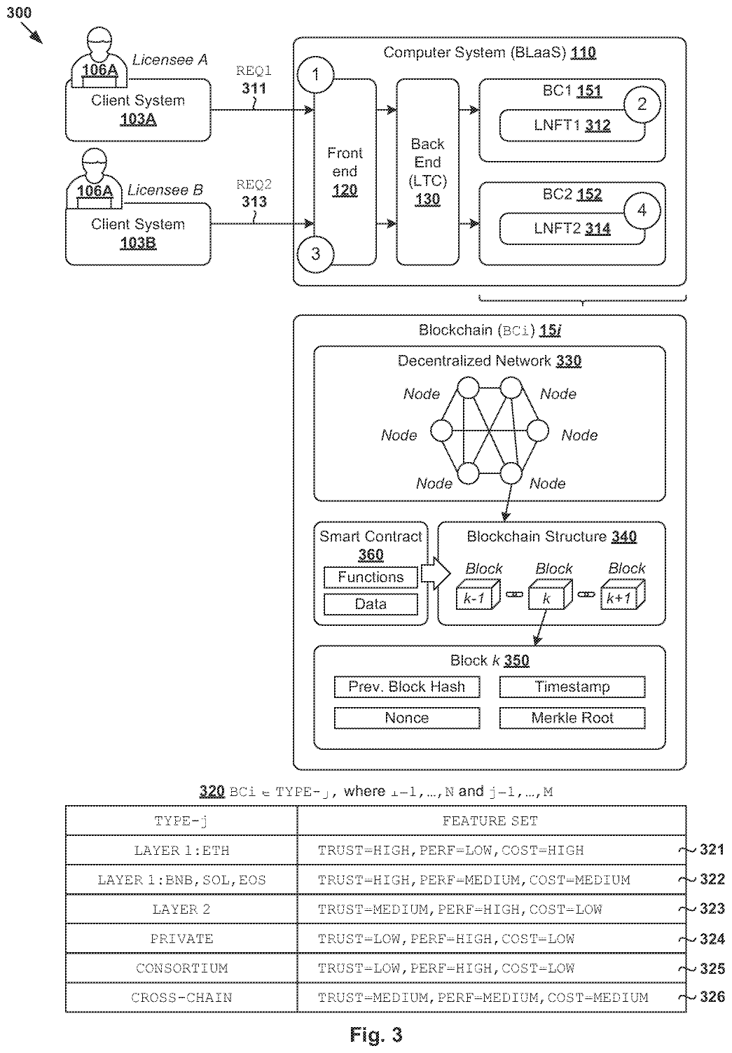

Backend sub-system 130 may include various components to provide licensing services supported by smart contract technology (see 134) and blockchain technology (see 150) to provide a high level of abstraction, such as license trading center (LTC) smart contract 140, license store smart contract 141, license price oracle (LPO) smart contract 142, license registrar smart contract 143, etc. In practice, LTC 140 may provide services relating to license registration, checking, trading, exchange, etc. Any suitable non-fungible token (NFT) marketplace 144 (e.g., OpenSea and Rarible) may be used for NFT trading relating to licensing. Smart contract (see 134) and blockchain (see 150) layers will be described further below using FIG. 3.

Using examples of the present disclosure, licensor 104/vendor 105 may establish virtual license store 141 on LTC 140, mint license type tokens (to be discussed further below) representing licenses available for acquisition and register those licenses on license store 141 for sale. License registrar 143 may be configured to store and track license type tokens minted by licensor 104. LPO 142 may be a blockchain oracle, such as to connect to a deterministic blockchain with off-chain data such as Ethereum/Tether (ETH/USDT) trading pair feed. Licensor 104 and/or vendor 105 may set license fee(s) using LPO 142. The license fee/price may be set in native token (e.g., ETH), fiat money (e.g., USDT or DAI) converted from LPO 142, etc.

### Licensing NFT

According to examples of the present disclosure, licenses may be represented or encoded using unique digital tokens that are recordable on blockchain(s). This includes licenses that are available for acquisition from licensor 104, as well as licenses acquired by vendor 105 or licensee 106. In this case, BLaaS system 110 may be implemented using any suitable technology relating to FT and NFT, semi-fungible token (SFT) and licensing NFT (LNFT); see 133 in FIG. 1. Implementation details may be found in various token standards, such as Ethereum Request for Comment (ERC) documents that include guidelines on developing smart contract(s), etc. Example token standards include ERC-721 entitled “Non-fungible token (NFT) standard,” ERC-1155 entitled “A standard for contracts that manage multiple token types,” ERC-4635 entitled “Semi-fungible token standard,” ERC-4636 entitled “Licensing token standard,” etc. In general, a token standard may define a set of functions for each token type to facilitate interaction between applications and smart contracts. These token standards are incorporated herein by reference.

In practice, the term “fungible token” or FT may refer generally to a token (or fraction of a token) that is equivalent to, and indistinguishable from, another token. The term “non-fungible token” or NFT may refer generally to a token that is not mutually interchangeable because of their individual (unique) specification. NFTs may be utilized as digital certificates to record the ownership of digital art, unique collectibles, virtual gaming items, domain names, physical assets, etc. For example, an asset (e.g., creative work) may be minted as NFT and its ownership transferred from a seller (e.g., creator) to a buyer. NFT may grant proof-of-ownership to an asset owner using blockchain and smart contract technology.

In contrast, according to examples of the present disclosure, a licensing relationship may be represented using SFT, which is both fungible and non-fungible during its lifecycle. SFT allows a license producer (i.e., licensor) to manage FT-type licenses with corresponding metadata, such as terms and conditions in a licensing agreement. For example, software companies may sell software licenses to grant customers (i.e., licensees) with rights to use its software, rather than to transfer ownership to those customers. In practice, several license types may be defined, each being associated with a service level and expiry date. Such license types may be taken as a type of fungible token. When one type of license is delivered to a licensee, the license may evolve into an NFT with unique metadata, such as the licensee's name, activated/expiry time, etc. SFTs may be implemented according to ERC-4635, which is derived from ERC-1155. Key features of ERC-4635 may include: (a) NFT is managed using ERC-721, (b) management of multiple types of FT, (c) a transition process from FT to NFT and (d) separate approval for FT and NFT for security reasons.

According to examples of the present disclosure, a licensing service smart contract may be implemented according to the licensing non-fungible token (LNFT) standard defined in ERC-4636, etc. Key features of ERC-4636 may include: (a) LNFT inherits its properties from SFT, (b) LNFT allows licensor/vendor to issue one type of license to licensee 106 as NFT, (c) licensor 104 may create multiple license types (FT) associated with respective licensing agreements, and (d) LNFT allows licensee 106 to obtain/check/activate/validate and trade a license. In practice, BLaaS system 110 implement ERC-4636 to provide unified interfaces to facilitate the implementation of various licensing scenarios required by users 104-106.

In a first example scenario, a software company may access BLaaS system 110 to deploy licensing services for software use (as mentioned above). In a second example, NFT owners may access BLaaS system 110 to generate licensing tokens based on their own NFT for exhibition use. In a third example, DApp provider(s) May access BLaaS system 110 to regulate types of very important persons (VIPs) as incentives to their regular customers. Further, gaming provider(s) may access BLaaS system 110 to build a licensing service contract so that players are able to rent their powerful game equipment. Since trust and security lie at the root of blockchain technology, and the LNFT standard defined in ERC-4636 is compatible with the NFT standard, BLaaS system 110 may be implemented to provide a platform where licenses may be exchanged freely and securely among parties without reliance of any third-party authentication.

### Blockchain-Based Licensing as a Service

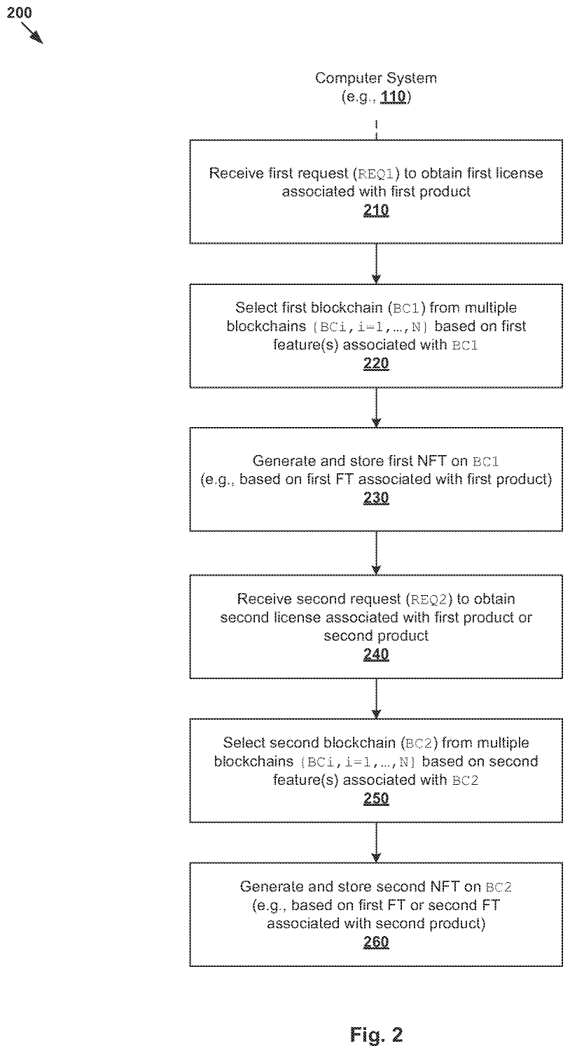

FIG. 2 is a flowchart of example process 200 for a computer system to perform. Example process 200 may include one or more operations, functions, or actions illustrated by one or more blocks, such as 210 to 260. Depending on the desired implementation, various blocks may be combined into fewer blocks, divided into additional blocks, and/or eliminated. Example process 200 will be explained using FIG. 3, which is a schematic diagram illustrating example blockchain-based licensing as a service 300 using multiple blockchains 150.

In the following, an example “computer system” will be explained using BLaaS system 110 that is capable of providing licensing services to various client systems. BLaaS system 110 may be configured to access multiple (N) blockchains (see 151-15N in FIG. 1) to implement blockchain-based licensing as a service according to examples of the present disclosure. Each blockchain may be denoted as BCi, where i∈1, . . . , N. For simplicity, the case of N=2 is shown in FIG. 3.

### (a) First Blockchain Selection

At 210 in FIGS. 2 and 311 in FIG. 3, BLaaS system 110 may receive a first request to obtain a first license associated with a first product, such as software, etc. For example in FIG. 3, the first request (denoted as REQ1) may be received from first client system 103A operated by first user=licensee A 106A.

At 220 in FIG. 2, in response to receiving the first request, BLaaS system 110 may select first blockchain=BC1 151 from multiple blockchains 150 based on first feature(s) associated with BC1 151. At 230, BLaaS system 110 may generate and store (i.e., mint) a first NFT on BC1 151 to issue the requested first license to first client system 103A or first user 106A. Block 230 may involve minting the first NFT based on a first FT associated with the first product. In the example in FIG. 3, the first NFT is denoted as “LNFT1” (see 312) to represent a first LNFT of type=NFT according to ERC-4636.

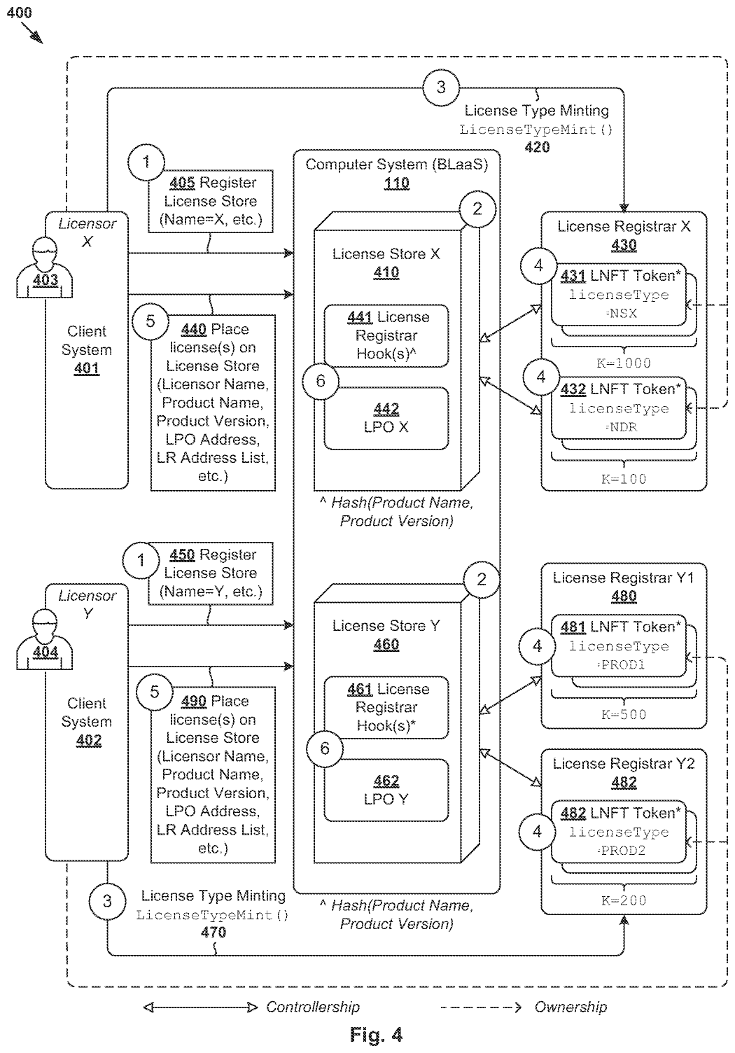

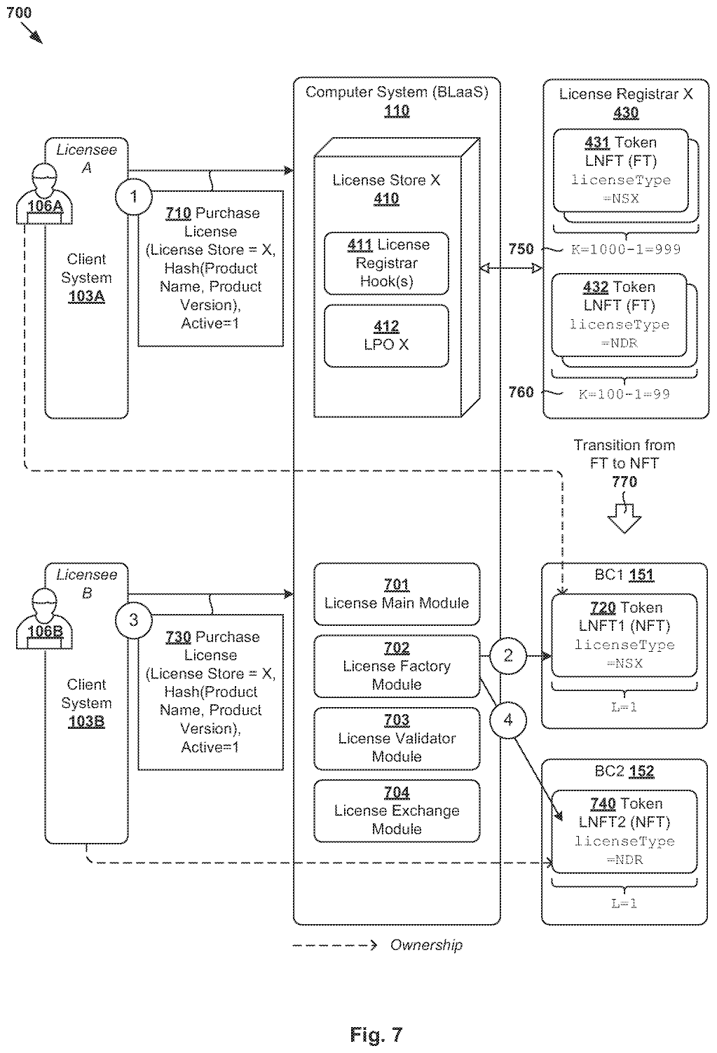

As used herein, the term “token” may refer generally to a digital asset that may be stored on a blockchain. In the context of BLaaS, at least two token types may be used according to ERC-4636. In a first example, a “license type token” (denoted as licenseType below) is an FT (i.e., fungible token) that may be minted to digitally represent a real-world license that is available for acquisition (e.g., listed for sale on a license store). In a second example, a “license token” is an NFT (i.e., non-fungible token) that may be minted to digitally represent a real-world license that is acquired by a licensee, either directly from a licensor or via a vendor. Example FTs will be discussed using FIG. 4 (e.g., 431/432/481/482), and example NFTs using FIG. 7 (e.g., 720/740).

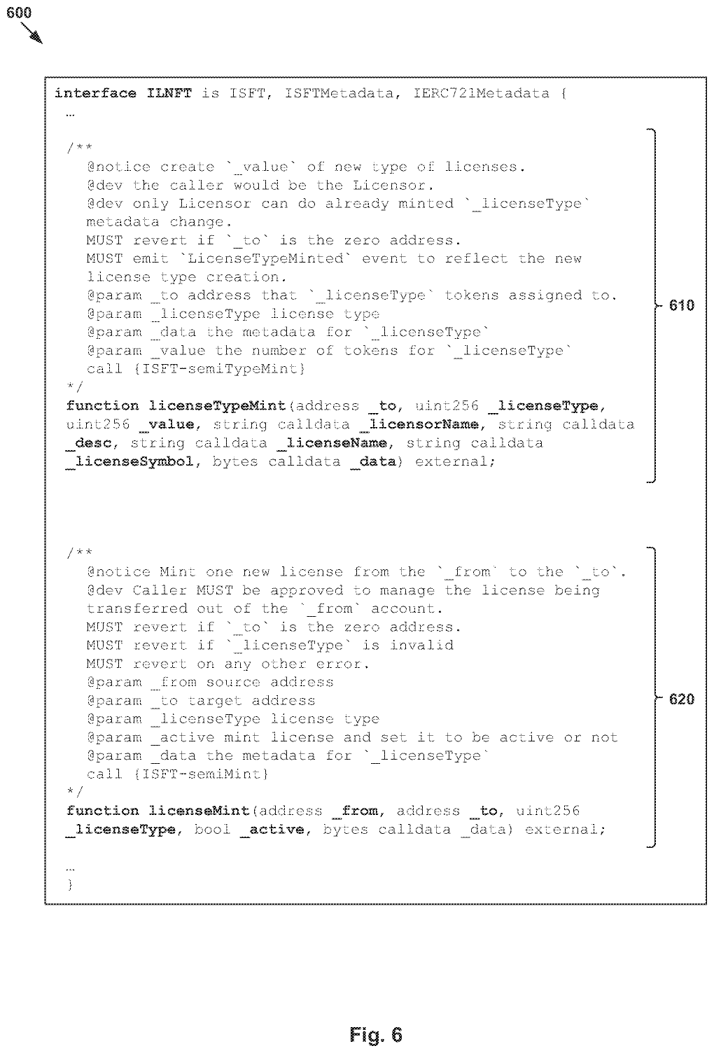

As used herein, the term “minting” may refer generally to generating and storing new token(s) on blockchain(s). In practice, minting may involve verification of data, creation of new block(s), recording data onto the blockchain, solving complex mathematical problems, etc. As will be described further below using FIGS. 4-8, block 230 may involve invoking a first smart contract function to mint LNFT1 312 based on the first FT, such as licenseMint( ) function defined in ERC-4636. Here, the “first FT” may be a license type token that is minted by licensor 104 based on first metadata associated with the first product. The first FT may be minted by invoking a second smart contract function, such as licenseTypeMint( ) function defined in ERC-4636. The licenseMint( ) and licenseTypeMint( ) functions will be discussed further using FIG. 6 (see 610-620).

### (b) Second Blockchain Selection

At 240 in FIGS. 2 and 313 in FIG. 3, BLaaS system 110 may receive a second request to obtain a second license associated with the first product or a second product. For example in FIG. 3, the second request (denoted as REQ2) may be received from second client system 103B operated by second user=licensee B 106B.

At 250 in FIG. 2, in response to receiving the second request, BLaaS system 110 may select second blockchain=BC2 152 from multiple blockchains 150 based on second feature(s) associated with BC2 152. At 260 in FIG. 2, BLaaS system 110 may generate and store (i.e., mint) a second NFT on BC2 152 to issue the requested second license to second client system 103B or second user 106B. Block 260 may be performed based on the first FT associated with the first product or a second FT associated with the second product. In FIG. 3, the second NFT is denoted as “LNFT2” (see 314) to represent a second LNFT of type=NFT according to ERC-4636.

Similarly, block 260 may involve invoking a first smart contract function to mint LNFT2 314 based on the first FT or the second FT, such as licenseMint( ) function defined in ERC-4636; see 620 in FIG. 6. Here, the second FT may be a license type token (denoted as “licenseType” below) that is minted by licensor 104 via BLaaS system 110 based on second metadata associated with the second product. The second FT may be minted by invoking a second smart contract function, such as licenseTypeMint( ) function defined in ERC-4636; see 610 in FIG. 6.

### Blockchain Features and Structure

According to examples of the present disclosure, BLaaS system 110 may leverage different blockchain implementation technologies to balance among different features. In the example in FIG. 3 (see 320), a particular blockchain (BCi) may be one of the following implementation technologies or types (denoted as TYPE-j): layer 1 blockchain, layer 2 blockchain, private blockchain, consortium blockchain, blockchain based on cross-chain technology, etc. The blockchain selection may be performed to balance among different features.

For example, BC1 151 may be selected based on first feature(s) associated with BC1 151 at block 220, and BC2 152 based on second feature(s) associated with BC2 152 at block 240. Any suitable feature(s) may be used to select a particular blockchain (denoted as BCi) from multiple (N) blockchains, such as trust level, performance level, and cost discussed below. Other features may include data security, data privacy, scalability, environmental consideration(s), whether high availability (HA) is implemented to reduce failure or downtime, etc. In the following, note that each feature level (e.g., high, medium, and low) may be defined using any suitable threshold(s) depending on the requirement(s) of licensor 104 or licensee 106A/106B. Any additional and/or alternative level indicator(s) for a particular feature may be used.

In relation to performance, a blockchain (BCi) may be associated with an estimated performance level based on their design principle(s). The performance level may be measured directly from the blockchain or obtained from official performance testing sites. In relation to trust, a blockchain (BCi) may be categorized into two types: Proof of Work (POW) and Proof of Stake (POS). In practice, usually POW is more secure than POS algorithm (but may not be that accurate). For blockchains with the same POW, the current hashing difficulty level may be used to indicate the trust level. Note that the trust level associated with public blockchains is the highest, followed by permissioned blockchains and then private blockchains, i.e., trust(public blockchain)>>trust(permissioned blockchain)>>trust(private blockchain).

At 321-322 in FIG. 3, a blockchain (BCi) selected at block 220/240 in FIG. 2 may be a layer 1 blockchain. In practice, the term “layer 1” may refer generally to a base blockchain. Layer 1 blockchains are generally capable of validating and finalizing transactions without the need for another network. For example, BC1 151 may be an Ethereum (ETH) blockchain that is associated with features that include (a) trust level=high, (b) performance level=low and (c) cost=high. For some licensors and/or licensees, the high cost associated with ETH may not be acceptable. In this case, BC2 152 may be a different layer 1 blockchain (e.g., BNB, SOL, or EOS) that is associated with (a) trust level=high, performance level=medium and cost=medium.

At 323 in FIG. 3, a blockchain (BCi) selected at block 220/240 in FIG. 2 may be a layer 2 blockchain. In practice, the term “layer 2” may refer generally to a blockchain that is built on top of a layer 1 blockchain, such as to improve scalability. One goal of scalability is to increase transaction speed (i.e., faster finality) and transaction throughput (e.g., higher transactions per second) without sacrificing decentralization or security. For example, BC1 151 may be a layer 1 blockchain, and BC2 152 a layer 2 blockchain that is associated with features that include (a) trust level=medium, performance level=high and cost=low.

At 324 in FIG. 3, a blockchain (BCi) selected at block 220/240 in FIG. 2 may be a private blockchain, such as AntChain, VMware Chain, etc. In practice, a private blockchain (also known as a permission-based blockchain) has more limited access in that only permitted users are allowed to participate. A trusted entity is usually in charge of running the private blockchain and controls who can access the blockchain. Private blockchains should be contrasted against public blockchains, which are accessible by anyone (i.e., public) who may wish to read, write, and audit ongoing activities on the public blockchains. Example features associated with a private blockchain may include (a) trust level=low, performance level=high and cost=low.

At 325 in FIG. 3, a blockchain (BCi) selected at block 220/240 in FIG. 2 may be a consortium blockchain, such as Hyperledger Fabric, Enterprise Ethereum Alliance (EEA), etc. In practice, a consortium blockchain is a blockchain that is run by a group of organizations (i.e., consortium blockchain providers) for access by users from those organizations. In terms of trust level, consortium blockchains may lie between public blockchains and private blockchains. Example features associated with a consortium blockchain may include (a) trust level=low, performance level=high and cost=low.

At 326 in FIG. 3, a blockchain (BCi) selected at block 220/240 in FIG. 2 may be a blockchain implemented using cross-chain technology, such as Polkadot (DOT), ATOM, etc. In practice, cross-chain technology is designed to increase the scalability of blockchain, and to facilitate data transfer across blockchains. For example, this makes it possible to build applications that get permissioned data from a private blockchain and use it on a public blockchain. Example features associated with a blockchain that is implemented using cross-chain technology may include (a) trust level=medium, performance level=medium and cost=medium. In practice, cross-chain technology may be selected based on the specific NFT use case. NFTs stored using cross-chain technology may have more use flexibility, such as useable and/or tradeable by multiple blockchains.

As used herein, the term “blockchain” may refer generally to a distributed database or ledger that is capable of storing data in blocks that are linked together in a chain. Unlike a traditional database that stores data in a centralized manner, blockchain is decentralized in that data is shared and replicated by multiple nodes in a network. Blockchain is immutable in that data (e.g., tokens) recorded on a blockchain generally cannot be changed or altered. At 330 in FIG. 3, each blockchain (BCi) may be implemented using a decentralized network of multiple nodes that each execute and record the same transactions.

At 340 in FIG. 3, a blockchain on a particular node may be formed using a chain of blocks. The blocks are linked together using cryptographic techniques to form a chronological chain of data. This is to reduce the risk of fraud because one change in any block would invalidate all the following blocks as all subsequent hash values would change. At 350 in FIG. 3, a particular block k may record a previous block hash (i.e., hash of block k−1), timestamp (i.e., time when mining ends), nonce, Merkel root, etc. In cryptography, nonce is a one-time code chosen randomly to transmit password securely and to reduce the risk of replay attacks.

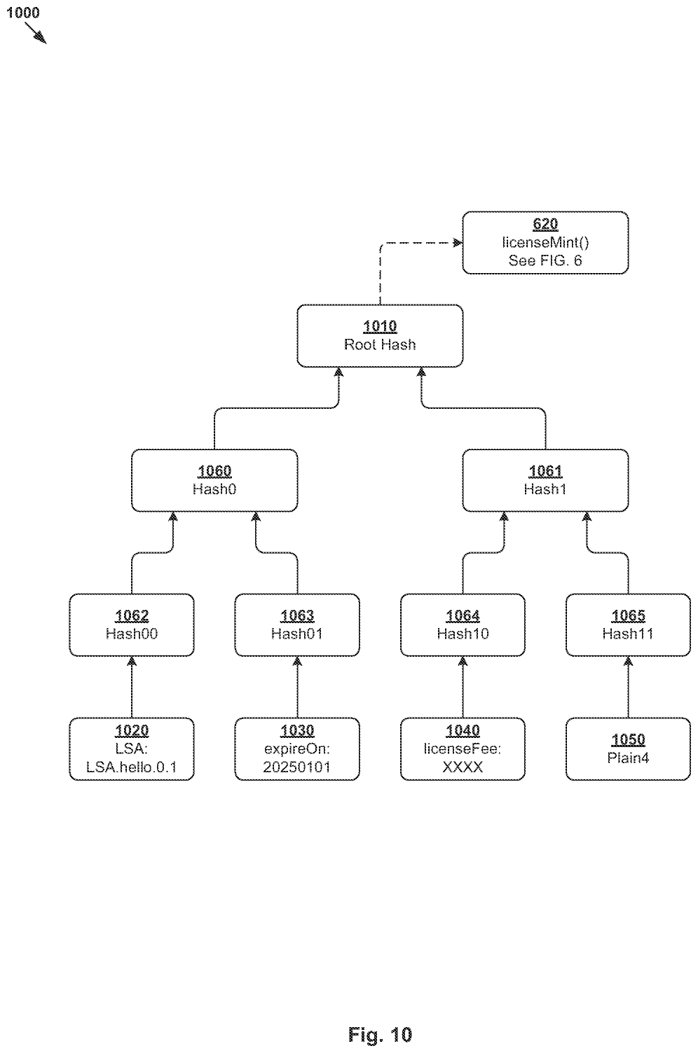

The Merkle root may represent a hash that is generated by hashing all hashes stored on leaf nodes of a Merkle tree, such as to guarantee that data blocks sent among nodes are undamaged and complete. Using examples of the present disclosure, details of a licensing process may be recorded on blockchains implemented based on Merkle tree technology. In at least some embodiments, this makes the licensing process trustless, while maintaining the privacy of sensitive data relating to licensing agreements, thereby addressing the concerns of some companies relating to the trust and privacy of conventional LaaS approaches. An example Merkle tree will be discussed using FIG. 10.

At 360 in FIG. 3, smart contract technology may be implemented to extend the functionality of blockchains beyond data recording. As used herein, the term “smart contract” may refer generally to program code that is executable on a blockchain. A smart contract may include a set of functions and data (its state) that reside at a specific address on a blockchain. Smart contracts may be written in any suitable smart contract language, such as Solidity, Vyper, etc. According to examples of the present disclosure, LTC 140, license store 141, LPO 142 and license registrar 143 may be implemented using smart contract technology.

In practice, smart contracts are unable to access information stored outside a blockchain. This is by design because reliance on external information may jeopardize consensus, which is important for security and decentralization. To get around this, oracles may be used, such as LPO 142 in FIG. 1. The term “oracle” may refer generally to any suitable approach to obtain external information from off the blockchain (i.e., off-chain) and place it on the blockchain (i.e., on-chain) for use by smart contract(s) running on the blockchain.

Depending on the desired implementation, BLaaS system 110 may be implemented using DApp technology. The term “decentralized application” (DApp) may refer generally to an application built on a decentralized network that combines a smart contract and a frontend user interface. Examples of the present disclosure may be implemented to provide licensing services for both off-chain applications (e.g., software licensing and LaaS) as well as on-chain applications (e.g., NFT, DApp, etc.).

### License Store Registration

According to examples of the present disclosure, BLaaS system 110 may provide various services to multiple licensors 104. For example, licensor 104 may obtain a customized licensing service smart contract from BLaaS system 110, such as by registering/establishing license store 141, LPO 142, license registrar 143, etc. Next, licensor 104 may mint one or more license type tokens and register them onto its license store 141 on LTC 140 similar to placing commodity for sale on an online store. Finally, using BLaaS system 110, licensor 104 may trade the license type tokens to vendor 105 and/or licensee 106. The license type tokens may follow any suitable token standards, such as ERC-4635 and ERC-4636 referenced above.

Two examples are shown in FIG. 4, which is a schematic diagram illustrating example license store registration. In a first example, BLaaS system 110 may provide a first customized licensing service to first licensor 403 (i.e., X) associated with first license store 410, license registrar(s) 430 and associated hook(s) 441, LPO 442, etc. In a second example, BLaaS system 110 may provide a second customized licensing service to second licensor 404 (i.e., Y) associated with second license store 460, license registrar(s) 480/482 and associated hook(s) 461, LPO 462, etc.

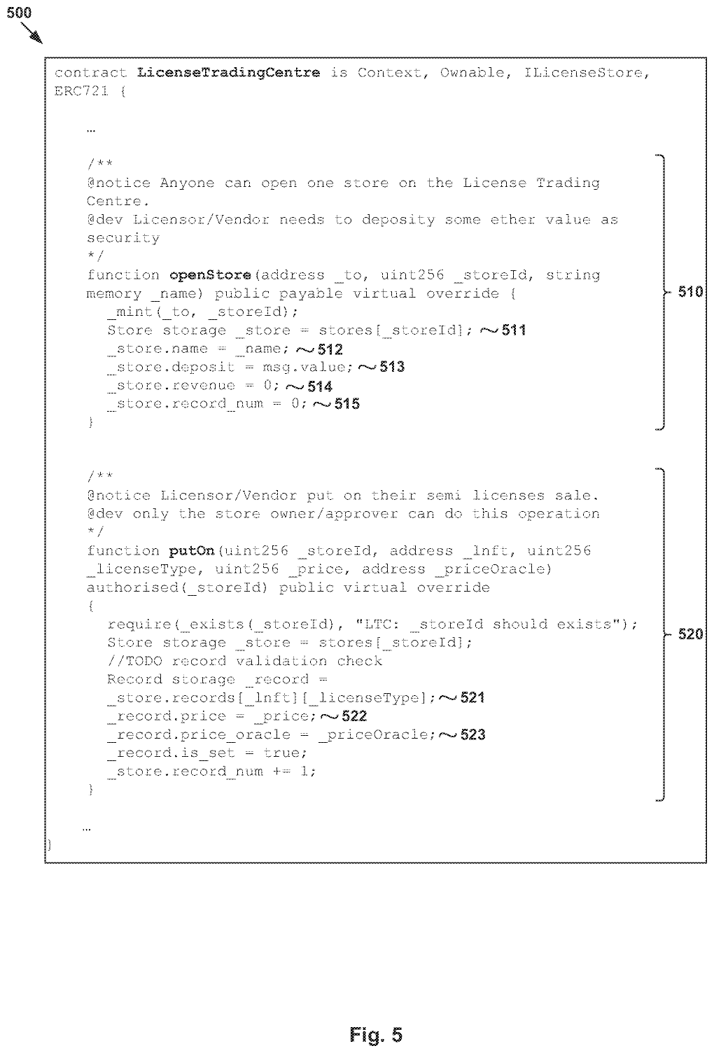

The examples in FIG. 4 will be described using FIGS. 5-6. Here, FIG. 5 is a diagram illustrating example smart contract implementation 500 for registering a license store registration and placing license type tokens on the license store. FIG. 6 is a diagram illustrating example token minting functions for blockchain-based licensing as a service. Although described using licensors 403-404, it should be noted that vendor(s) may open a license store in a similar manner.

### (a) First Licensor=X

At 405-410 in FIG. 4, based on a first request from first client system 401 operated by first licensor 403, BLaaS system 110 may register a first license store=X on LTC 140. As part of the license store registration process, first licensor 403 may pay any suitable registration fee and security deposit to an account associated with BLaaS system 110. First request 405 may include any suitable input parameter(s), such as license store name=X, etc.

Using the example in FIG. 5, LTC 140 may implement a license store interface to facilitate license store registration using function=openStore( ) see 510. Function openStore( ) may be invoked based on input parameter(s) specified by first request 405. For example in FIG. 5, license store 410 may be associated with any suitable attributes, such as a store ID (see 511), name (see 512), deposit amount (see 513), revenue amount (see 514), number of license records (see 515), etc. Once registered, license store 410 may represent a virtual store on LTC 140 where first licensor 403 may place licenses for sale.

At 420 in FIG. 4, multiple licenseType tokens (i.e., FT tokens) may be minted and stored on license registrar 430 associated with first licensor 403, such as by calling or invoking function=licenseTypeMint( ) specified by the LFNT standard in ERC-4636 (see 610 in FIG. 6) via BLaaS system 110. For example (see 431), function=licenseTypeMint( ) may be invoked to mint K=1000 license Type tokens representing 1000 licenses associated with a first product (e.g., type=NSX).

In another example (see 432), function=license TypeMint( ) may be invoked via BLaaS system 110 to mint K=100 license Type tokens representing 100 licenses of second product (e.g., type=NDR). These tokens 431-432 may be stored on license registrar 430 associated with first licensor 403. Based on the LFNT standard defined in ERC-4636, the scope of each licenseType token may be defined using metadata, such as product information (e.g., name and version, etc.). Note that VMware NSX® and Network Detection and Response (NDR) are SDN solutions provided by VMware, Inc. These solutions may be implemented in any suitable SDN environment, an example of which is shown in FIG. 11.

At 440 FIG. 4, BLaaS system 110 may receive a second request to place or register license(s) for sale on license store 410 from first client system 401 operated by licensor 403. This involves updating license store 410 to indicate that license(s) represented by license Type tokens 431-432 are available for acquisition. As part of the registration process, licensor 403 may pay any suitable fee (e.g., in cryptocurrency) to cover calling fees, license registration fee and a security deposit to an account associated with BLaaS system 110. Second request 440 may include any suitable input parameter(s), such as licensor's name; product information (e.g., product name and version); LPO address information associated with LPO 442 that calculates the license fee; license registrar address information associated with license registrar 430, etc.

In response, BLaaS system 110 may update license store 410 based on second request 430. For example, license store 410 may be updated to include a license registrar hook (see 441) associated with a hash number that is generated based on product information (e.g., product name=NSX and version). There is a binding relationship between licenses (licenseType tokens 431/432) on license registrar 430 and LPO 442. Using the example in FIG. 5 (see 520), LTC 140 may implement a license store interface that includes function=putOn( ) to facilitate license(s) for sale on a particular license store assigned with a store ID (storeId).

In practice, putOn( ) may be invoked or called based on input parameter(s) in second request 430. Once putOn( ) is called, the input parameter(s) may go into a blockchain (i.e., license store smart contract) after validation. The validation process may involve checking whether the requestor's address is an owner of the LNFT address and license type. If yes, license store 410 may be updated to include a new license record. Smart contract programming language (e.g., Solidity) ensures that record's data is serialized into the blockchain as raw data. Each license record may be associated with any suitable attributes, such as address information associated with license Type tokens 431/432, license fee, LPO address, etc. See 521-523 in FIG. 5.

### (b) Second Licensor=Y

At 450-460 in FIG. 4, based on a third request from second client system 402 operated by second licensor 404, BLaaS system 110 may register a second license store=Y on LTC 140. Similarly, second licensor 404 may pay any suitable registration fee and security deposit to an account associated with BLaaS system 110. Third request 450 may include any suitable input parameter(s), such as license store name=Y, etc. Using the example in FIG. 5, function openStore( ) may be invoked based on input parameter(s) specified by third request 450. Once registered, second licensor 404 may place licenses on license store 460 for sale.

At 470 in FIG. 4, multiple license Type tokens (i.e., FT tokens) may be minted and stored on multiple license registrars 480 associated with second licensor 404, such as by calling or invoking smart contract function=licenseTypeMint( ) For example (see 481), function=license TypeMint( ) may be invoked to mint K=500 license Type tokens representing 500 licenses of a first product (e.g., type=PROD1). In another example (see 482), function=license TypeMint( ) may be invoked to mint K=200 licenseType tokens representing 200 licenses of a second product (e.g., type=PROD2).

In the example in FIG. 4, second licensor 404 may be associated with multiple license registrars. First license registrar=Y1 (see 480) may be used to store K=500 licenseType tokens 481 associated with the first product. Second license registrar=Y2 (see 484) may be used to store K=200 license Type tokens 482 associated with the second product. The scope of each license Type token may be defined using metadata, such as product information (e.g., name and version, etc.).

At 490 FIG. 4, BLaaS system 110 may receive a fourth request to update license store 460 from second licensor 404. As part of the registration process, licensor 404 may pay any suitable fee(s) to an account associated with BLaaS system 110. Fourth request 490 may include any suitable input parameter(s), such as licensor's name; product information (e.g., product name=NDR and version); LPO address information associated with LPO 462; license registrar address information, etc.

To support multiple blockchains with different features, the license registrar address information may be a list that includes a first address associated with first license registrar=Y1 480, and a second address associated with second license registrar=Y2 484. Here, the first address and second address may represent different blockchains that licensor 404 may choose for NFT acquisition. Licensor 404 may also provide blockchain ID information (e.g., ETH by default) in request 490. For example, licensor 404 who wishes to support license acquisition on both ETH and BNB blockchains may provide first blockchain ID=1 identifying ETH and second blockchain ID=56 identifying BNB. These IDs are unique across various blockchains to identity the respective blockchains.

In response to fourth request 480, BLaaS system 110 may update license store 460 to indicate that licenses represented by licenseType tokens 481-482 are available for acquisition. This may include updating license store 460 to include one or more license registrar hooks (see 461) that are each associated with a hash number that is generated based on product information (e.g., product name and version). There is a binding relationship between licenses (represented using licenseType tokens 481/482) on license registrar 480/484 and LPO 462. Using the example in FIG. 5 (see 520-523), function=putOn( ) may be invoked or called based on input parameter(s) in fourth request 480.

### License Acquisition

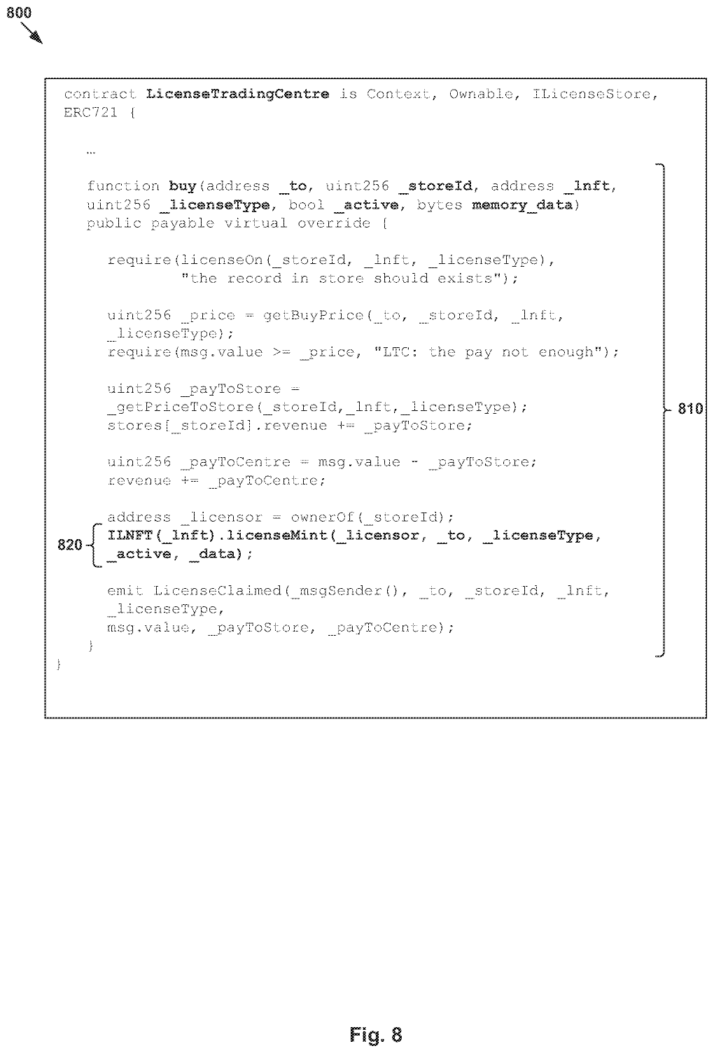

According to examples of the present disclosure, BLaaS system 110 may provide license acquisition services by leveraging the trust and security provided by blockchain technology. Some examples will be described using FIG. 7, which is a schematic diagram illustrating example license acquisition 700 by licensee(s) from licensor(s) or vendor(s). The example in FIG. 7 will be explained using FIG. 8, which is a diagram illustrating example smart contract implementation 800 for purchasing a license listed on a license store.

In the following examples, BLaaS system 110 may include various module(s) or component(s) to handle licensing requests from licensee 103A/103B. For example, LTC 140 in FIG. 1 may further include main module 701, license factory 702, license validator 703, license exchange module 704, etc. In practice, licensee 106A/106B may obtain pricing information associated with a license via LPO 412 before sending a request to BLaaS system 110 (e.g., LTC 140) to purchase the license.

### (a) First Licensee=A

In a first example in FIG. 7, first licensee A 106A may wish to obtain a license to use a first product associated with licenseType=NSX token (see 431). At 710 in FIG. 7, first licensee 106A may generate and send a licensing request to BLaaS system 110 (e.g., LTC 140). The request may include any suitable parameter(s), such as licensor's name, store ID associated with license store 410, a hash value that is generated based on product information (e.g., product name=NSX and version number), active flag indicating whether to activate the license, etc.

At 720 in FIG. 7, in response to receiving request 710, BLaaS system 110 may mint a first license token=LNFT1 (i.e., NFT) on first blockchain=BC1 151 based on licenseType=NSX token (i.e., FT). As described using FIG. 3, BLaaS system 110 may select BC1 151 based on feature(s) associated with BC1 151, such as based on trust/performance/cost requirement(s) specified by licensor 401 and/or licensee 106A. In practice, main module 701 acting as a “main entrance” for all licensing requests may call license factory 702 to generate the license token and assign its ownership to licensee 106A.

Using the example in FIG. 8 (see 810), LTC 140 may implement a license store interface that includes function=buy( ) which may be called or invoked using input parameters in request 710. Once transaction verification is successful (e.g., check whether license store 410 exists and licensee 106A has enough funds), LTC 140 may transfer a percentage of the license fee to its own account as service fee and the remaining into an account associated with license store 410 as license fee. Next, license factory 702 may mint one license token (i.e., LNFT1 720) by invoking smart contract function=licenseMint( ) described using FIG. 6 (see 620). Here, LNFT1 720 may be minted based on licenseType=NSX token 431, and metadata (e.g., licensing agreement) associated with license Type=NSX token 431.

### (b) Second Licensee=B

In a second example in FIG. 7, second licensee 106B may wish to obtain a license to use a second product associated with license Type=NDR (see 432). At 730 in FIG. 7, second licensee 106B may generate and send a licensing request to BLaaS system 110 (e.g., LTC 140). The request may include any suitable parameter(s), such as licensor's name, store ID associated with license store 410, a hash value that is generated based on product information (e.g., product name=NDR and version number), active flag indicating whether to activate the license, etc.

At 740 in FIG. 7, in response to receiving request 730, BLaaS system 110 may mint a second license token=LNFT2 (i.e., NFT) on second blockchain=BC2 152 based on license Type=NDR token (i.e., FT). Similar to the first example, BLaaS system 110 may select BC2 152 based on feature(s) associated with BC2 152, such as based on trust/performance/cost requirement(s) specified by licensor 401 and/or licensee 106B.

Using the example in FIG. 8 (see 810), LTC 140 may implement a license store interface that includes function=buy( ) which may be called or invoked using input parameters in request 730. Once transaction verification is successful (e.g., check whether license store 410 exists and licensee 106B has enough funds), LTC 140 may deduct service and license fees from an account associated with licensee 106B. Next, license factory 702 may mint one license token (i.e., LNFT2 740) by invoking smart contract function (see 820 in FIG. 8)=licenseMint( ) described using FIG. 6. Here, LNFT2 740 (i.e., NFT) may be minted based on licenseType=NDR token 432, and metadata (e.g., licensing agreement) associated with license Type=NDR token 432.

Further, at 750 in FIG. 7, the number of license Type=NSX tokens 431 that are available for acquisition may be reduced by one, such as from 1000 to 999. Similarly, at 760, the number of license Type=NDR tokens 432 may be reduced by one, such as from 100 to 99. Using examples of the present disclosure, the transition process from FT to NFT may be abstracted using ERC-4636. In both examples in FIG. 7, license validator 703 may handle any request to validate whether licensee 106A has obtained a license, such as based on address information of LNFT 720/740 and its token ID. License exchange module 704 may be configured to handle request(s) for trading/exchanging LNFT 720/740.

Depending on the desired implementation, smart contract technology may be used to issue, for example, a DApp VIP license token to licensee 106A/106B. This way, licensee 106A/106B owning this VIP license token may access some technology from the licensor's website. In another example, a perpetual license token may be issued using smart contract implementation following ERC-4636. Any licensee 106A/106B owning this perpetual license token may use the associated product perpetually.

### Vendor Use Case

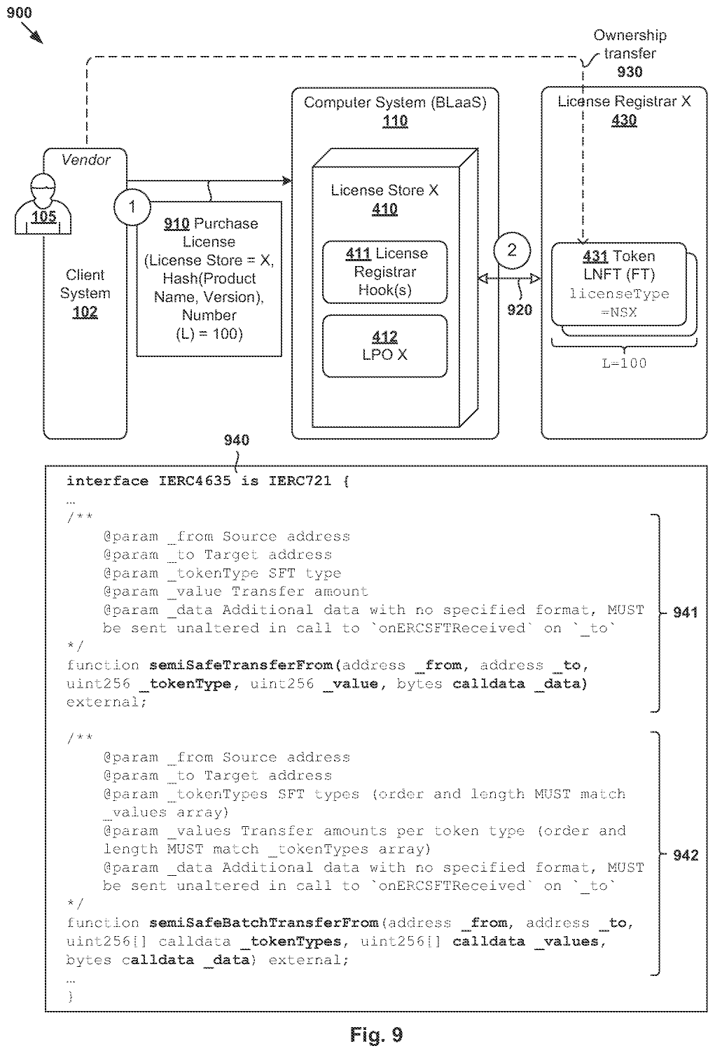

According to examples of the present disclosure, BLaaS system 110 may provide license acquisition services to vendor(s) acting as an intermediary between a licensor and a licensee. Some examples will be described using FIG. 9, which is a schematic diagram illustrating example license acquisition 900 by a vendor from a licensor. For example, vendor 105 may purchase/acquire a batch of multiple licenses 105 from licensor 403/404 in the example in FIG. 4 for subsequent distribution to licensee 106A/106B in the example in FIG. 7.

At 910 in FIG. 9, vendor 105 may generate and send a request to BLaaS system 110 (e.g., LTC 140) to obtain multiple licenses associated with license Type=NSX (see 431) from licensor 403. The request may include any suitable parameter(s), such as licensor's name, store ID associated with license store 410, a hash value that is generated based on product information (e.g., product name=NSX and/or version number), number of licenses to be transferred (e.g., L=100 out of K=1000), etc.

At 920-930 in FIG. 9, in response to receiving request 910, BLaaS system 110 may transfer ownership of multiple licenseType=NSX tokens (i.e., FT) from licensor 403 to vendor 105. In practice, this may involve calling or invoking function=semiSafe TransferFrom( ) or semiSafeBatchTransferFrom( ) specified by the SFT standard in ERC-4635, a snippet of which is shown at 940. For example (see 941), function=semiSafeTransferFrom( ) may be called to transfer ownership of one license Type token from licensor 403 to vendor 105.

Alternatively (see 942), function=semiSafeBatchTransferFrom( ) may be called to transfer ownership of a batch of multiple licenseType tokens from licensor 403 to vendor 105. Once ownership transfer is completed, vendor 105 may update own license store (not shown for simplicity) to indicate that license Type=NSX tokens 431 are available for acquisition from vendor 105 instead of licensor 104. This may be performed using the license store registration process explained using FIGS. 4-6. The implementation details are applicable here and not repeated for brevity.

### Discussions Relating to Improved Trust and Security

According to examples of the present disclosure, BLaaS system 110 may be implemented to provide improved trust and security for licensing services by leveraging blockchain technology, such as hash pointer, Merkle tree, directed acyclic graph (DAG), etc. Once data is recorded on a blockchain, the data becomes public and cannot be altered or removed. In practice, security may be defined using four characters: confidentiality, integrity, authentication, and non-repudiation. In term of confidentiality (i.e., data privacy) that is important for licensing agreements, examples of the present disclosure may be implemented based on a license agreement standard (LAS), such as “LAS.hello.0.1” in the example in FIG. 10.

FIG. 10 is a schematic diagram illustrating example Merkle tree 1000 for blockchain-based licensing as a service. Any licensing agreement that follows this standard may include a specific line: “LAS: LAS.hello.0.1.” For example, the “LAS.hello.0.1” may be defined as follows. (1) The licensing agreement is stored on a Merkle tree structure. (2) One leaf node (see 1020) may include “LAS: LAS.hello.0.1” to indicate that it is following the standard. (3) All rules may be defined using a key: value mapping that is stored on a single leaf node (see 1020-1050). (4) Metadata=expireOn (see 1030) to specify a timestamp indicating when the license expires. (5) Metadata=license fee or price (see 1040) to specify a random string (e.g., XXXX). The license fee is usually sensitive information that needs to be private (i.e., confidentiality required).

In the example in FIG. 10, Merkle tree 1000 may include leaf nodes for the LAS and parameter=expireOn (see 1020-1030). Only root hash (see 1010) may be stored on a license token (e.g., LNFT 720/740) when function=licenseMint( ) is called in the example in FIG. 7. Both licensor 403 and licensee 106A/106B would know the context information/metadata of the licensing agreement, and licensee 106A/106B may validate whether the root hash value is correct and use the value for minting. All others that are not parties to the licensing agreement would not be able to access the context information and the license fee information (i.e., kept private). Even when a hacker is able to expose the “Hash10” value (see 1064) and enumerate the license fee naming convention, only the random string may be exposed.

If licensor 403 decides to terminate the license before the expireOn date, licensee 106A/106B may expose the LSA, expireOn and hash values 1060-1065 (e.g., hash00, hash01, hash0 and hash1) to validate root hash value 1010 as proof. This may be performed while keeping parameter=license fee (see 1040) private. Further, examples of the present disclosure may be to improve integrity relating to licensing services. For example, integrity may be implemented by putting the root hash key (see 1010) into LNFT 720/740. Authentication may be ensured by the LNFT's licensor and licensee roles, in that licensee 106A/106B may prove that they have LNFT 720/740 by a simple signing with its private key.

### Example Network Environment

Examples of the present disclosure may be implemented to provide licensing services to product(s) and/or service(s) relating to SDN environment. An example will be described using FIG. 11, which is a schematic diagram illustrating an example SDN environment for which blockchain-based licensing as a service may be implemented. It should be understood that, depending on the desired implementation, FIG. 11 may include additional and/or alternative components. In practice, SDN environment 100 may include any number of hosts (also known as “computer systems,” “computing devices”, “host computers”, “host devices”, “physical servers”, “server systems”, “transport nodes,” etc.).

For example, various license Type and license tokens may be minted according to FIGS. 1-10 to facilitate licensing of software relating to VMware NSX® Intelligence (i.e., licenseType=NSX) and NDR (i.e., licenseType=NDR). Here, NSX intelligence is a distributed analytics engine to provide data-center-wide visibility to improve the process of operationalizing micro-segmentation, etc. NDR may refer to a threat correlation and forensics engine to facilitate detection of malicious activities and block threats.

In the example in FIG. 11, SDN environment 100 may include host-A 1110A and host-B 1110B. Host 1110A/1110B may include suitable hardware 1112A/1112B and virtualization software (e.g., hypervisor-A 1114A, hypervisor-B 1114B) to support various VMs. For example, host-A 1110A may support VM1 1131 and VM2 1132, while VM3 1133 and VM7 1137 are supported by host-B 1110B. Hardware 1112A/1112B includes suitable physical components, such as central processing unit(s) (CPU(s)) or processor(s) 1120A/1120B; memory 1122A/1122B; physical network interface controllers (PNICs) 1124A/1124B; and storage disk(s) 1126A/1126B, etc.

Hypervisor 1114A/1114B maintains a mapping between underlying hardware 1112A/1112B and virtual resources allocated to respective VMs. Virtual resources are allocated to respective VMs 1131-1134 to support a guest operating system (OS; not shown for simplicity) and application(s); see 1141-1144, 1151-1154. For example, the virtual resources may include virtual CPU, guest physical memory, virtual disk, virtual network interface controller (VNIC), etc. Hardware resources may be emulated using virtual machine monitors (VMMs). For example in FIG. 11, VNICs 1161-1164 are virtual network adapters for VMs 1131-1134, respectively, and are emulated by corresponding VMMs (not shown) instantiated by their respective hypervisor at respective host-A 1110A and host-B 1110B. The VMMs may be considered as part of respective VMs, or alternatively, separated from the VMs. Although one-to-one relationships are shown, one VM may be associated with multiple VNICs (each VNIC having its own network address).

Although examples of the present disclosure refer to VMs, it should be understood that a “virtual machine” running on a host is merely one example of a “virtualized computing instance” or “workload.” A virtualized computing instance may represent an addressable data compute node (DCN) or isolated user space instance. In practice, any suitable technology may be used to provide isolated user space instances, not just hardware virtualization. Other virtualized computing instances may include containers (e.g., running within a VM or on top of a host operating system without the need for a hypervisor or separate operating system or implemented as an operating system level virtualization), virtual private servers, client computers, etc. Such container technology is available from, among others, Docker, Inc. The VMs may also be complete computational environments, containing virtual equivalents of the hardware and software components of a physical computing system.

The term “container” (also known as “container instance”) is used generally to describe an application that is encapsulated with all its dependencies (e.g., binaries, libraries, etc.). For example, multiple containers may be executed as isolated processes inside a VM, where a different VNIC is configured for each container. Each container is “OS-less”, meaning that it does not include any OS that could weigh 10s of Gigabytes (GB). This makes containers more lightweight, portable, efficient, and suitable for delivery into an isolated OS environment. Running containers inside a VM (known as “containers-on-virtual-machine” approach) not only leverages the benefits of container technologies but also that of virtualization technologies.

The term “hypervisor” may refer generally to a software layer or component that supports the execution of multiple virtualized computing instances, including system-level software in guest VMs that supports namespace containers such as Docker, etc. Hypervisors 1114A-B may each implement any suitable virtualization technology, such as VMware ESX® or ESXi™ (available from VMware, Inc.), Kernel-based Virtual Machine (KVM), etc. The term “packet” may refer generally to a group of bits that can be transported together, and may be in another form, such as “frame,” “message,” “segment,” etc. The term “traffic” or “flow” may refer generally to multiple packets. The term “layer-2” may refer generally to a link layer or media access control (MAC) layer; “layer-3” a network or IP layer; and “layer-4” a transport layer (e.g., using Transmission Control Protocol (TCP), User Datagram Protocol (UDP), etc.), in the Open System Interconnection (OSI) model, although the concepts described herein may be used with other networking models.

SDN controller 1170 and SDN manager 1172 are example network management entities. One example of an SDN controller is the NSX controller component of VMware NSX® (available from VMware, Inc.) that operates on a central control plane. SDN controller 1170 may be a member of a controller cluster (not shown for simplicity) that is configurable using SDN manager 1172. Network management entity 1170/1172 may be implemented using physical machine(s), VM(s), or both. To send or receive control information, a local control plane (LCP) agent (not shown) on host 1110A/1110B may interact with SDN controller 1170 via a control-plane channel.

Through virtualization of networking services in SDN environment 100, logical networks (also referred to as overlay networks or logical overlay networks) may be provisioned, changed, stored, deleted, and restored programmatically without having to reconfigure the underlying physical hardware architecture. Hypervisor 1114A/1114B implements virtual switch 1115A/1115B and logical distributed router (DR) instance 1117A/1117B to handle egress packets from, and ingress packets to, VMs 1131-1134. In SDN environment 100, logical switches and logical DRs may be implemented in a distributed manner and can span multiple hosts.

For example, a logical switch (LS) may be deployed to provide logical layer-11 connectivity (i.e., an overlay network) to VMs 1131-1134. A logical switch may be implemented collectively by virtual switches 1115A-B and represented internally using forwarding tables 1116A-B at respective virtual switches 1115A-B. Forwarding tables 1116A-B may each include entries that collectively implement the respective logical switches. Further, logical DRs that provide logical layer-3 connectivity may be implemented collectively by DR instances 1117A-B and represented internally using routing tables (not shown) at respective DR instances 1117A-B. Each routing table may include entries that collectively implement the respective logical DRs.

Packets may be received from, or sent to, each VM via an associated logical port. For example, logical switch ports 1165-1168 (labelled “LSP1” to “LSP4”) are associated with respective VMs 1131-1134. Here, the term “logical port” or “logical switch port” may refer generally to a port on a logical switch to which a virtualized computing instance is connected. A “logical switch” may refer generally to a software-defined networking (SDN) construct that is collectively implemented by virtual switches 1115A-B, whereas a “virtual switch” may refer generally to a software switch or software implementation of a physical switch. In practice, there is usually a one-to-one mapping between a logical port on a logical switch and a virtual port on virtual switch 1115A/1115B. However, the mapping may change in some scenarios, such as when the logical port is mapped to a different virtual port on a different virtual switch after migration of the corresponding virtualized computing instance (e.g., when the source host and destination host do not have a distributed virtual switch spanning them).

A logical overlay network may be formed using any suitable tunneling protocol, such as Virtual extensible Local Area Network (VXLAN), Stateless Transport Tunneling (STT), Generic Network Virtualization Encapsulation (GENEVE), Generic Routing Encapsulation (GRE), etc. For example, VXLAN is a layer-2 overlay scheme on a layer-3 network that uses tunnel encapsulation to extend layer-2 segments across multiple hosts which may reside on different physical networks. Hypervisor 1114A/1114B may implement virtual tunnel endpoint (VTEP) 1119A/1119B to encapsulate and decapsulate packets with an outer header (also known as a tunnel header) identifying the relevant logical overlay network (e.g., VNI). Hosts 1110A-B may maintain data-plane connectivity with each other via physical network 1105 to facilitate east-west communication among VMs 1131-1134.

### Computer System

The above examples can be implemented by hardware (including hardware logic circuitry), software or firmware or a combination thereof. The above examples may be implemented by any suitable computing device, computer system, etc. The computer system may include processor(s), memory unit(s) and physical NIC(s) that may communicate with each other via a communication bus, etc. The computer system capable of acting as BLaaS system 110 may include a non-transitory computer-readable medium having stored thereon instructions or program code that, when executed by the processor, cause the processor to perform processes described herein.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software and/or to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. Those skilled in the art will understand that the units in the device in the examples can be arranged in the device in the examples as described or can be alternatively located in one or more devices different from that in the examples. The units in the examples described can be combined into one module or further divided into a plurality of sub-units.

1. A method for a computer system to perform blockchain-based licensing as a service, wherein the method comprises:
in response to receiving, from a first client system associated with a first user, a first request to obtain a first license associated with a first product,
selecting, from multiple blockchains accessible by the computer system, a first blockchain based on one or more first features associated with the first blockchain, wherein the multiple blockchains include at least the first blockchain and a second blockchain; and
based on a first fungible token (FT) associated with the first product, generating and storing a first non-fungible token (NFT) on the first blockchain to issue the first license; and
in response to receiving, from a second client system associated with a second user, a second request to obtain a second license associated with the first product or a second product,
selecting, from the multiple blockchains, the second blockchain based on one or more second features associated with the second blockchain; and
based on the first FT or a second FT associated with the second product, generating and storing a second NFT on the second blockchain to issue the second license.

2. The method of claim 1, wherein selecting the first blockchain comprises:
selecting the first blockchain based on one or more of the following first features associated with the first blockchain: trust level, performance level and cost.

3. The method of claim 1, wherein selecting the first blockchain and the second blockchain comprises:
selecting the first blockchain and the second blockchain from the multiple blockchains that are each implemented using one of the following: layer 1 blockchain technology, layer 2 blockchain technology, private blockchain technology, consortium blockchain technology and cross-chain technology.

4. The method of claim 1, wherein the method further comprises:
prior to receiving the first request, generating and storing the first FT on a first license registrar with a first licensor; and
updating a first license store associated with the first licensor to indicate that the first FT is available for acquisition.

5. The method of claim 4, wherein the method further comprises:
prior to receiving the first request, transferring ownership of the first FT from the first licensor to a vendor; and
updating a second license store associated with the vendor to indicate that the first FT is available for acquisition.

6. The method of claim 1, wherein generating and storing the first NFT comprises:
generating and storing the first NFT to include metadata that is stored using a Merkle tree structure, wherein the metadata includes an expiry date and an amount of license fee associated with the first license.

7. The method of claim 1, wherein generating and storing the first NFT comprises:
calling or invoking a smart contract function to mint the first NFT on the first blockchain based on the first FT associated with the first product.

8. A non-transitory computer-readable storage medium that includes a set of instructions which, in response to execution by a processor of a computer system, cause the processor to perform blockchain-based licensing as a service, wherein the method comprises:
in response to receiving, from a first client system associated with a first user, a first request to obtain a first license associated with a first product,
selecting, from multiple blockchains accessible by the computer system, a first blockchain based on one or more first features associated with the first blockchain, wherein the multiple blockchains include at least the first blockchain and a second blockchain; and
generating and storing a first token on the first blockchain to issue the first license to the first client system or the first user; and
in response to receiving, from a second client system associated with a second user, a second request to obtain a second license associated with the first product or a second product,
selecting, from the multiple blockchains, the second blockchain based on one or more second features associated with the second blockchain; and
generating and storing a second token on the second blockchain to issue the second license to the second client system or the second user.

9. The non-transitory computer-readable storage medium of claim 8, wherein selecting the first blockchain comprises:
selecting the first blockchain based on one or more of the following first features associated with the first blockchain: trust level, performance level and cost.

10. The non-transitory computer-readable storage medium of claim 8, wherein selecting the first blockchain comprises:
selecting the first blockchain from the multiple blockchains that are each implemented using one of the following: layer 1 blockchain technology, layer 2 blockchain technology, private blockchain technology, consortium blockchain technology and cross-chain technology.

11. The non-transitory computer-readable storage medium of claim 8, wherein generating and storing the first token and the second token comprises:
generating and storing the first token, being a first non-fungible token (NFT), on the first blockchain based on a first fungible token (FT) associated with the first product; and
generating and storing the second token, being a second NFT, on the second blockchain based on the first FT or a second FT associated with the second product.

12. The non-transitory computer-readable storage medium of claim 11, wherein the method further comprises:
prior to receiving the first request, generating and storing the first FT on a first license registrar with a first licensor; and
updating a first license store associated with a first licensor to indicate that the first FT is available for acquisition.

13. The non-transitory computer-readable storage medium of claim 12, wherein the method further comprises:
prior to receiving the first request, transferring ownership of the first FT from the first licensor to a vendor; and
updating a second license store associated with the vendor to indicate that the first FT is available for acquisition.

14. The non-transitory computer-readable storage medium of claim 8, wherein generating and storing the first NFT comprises:
generating and storing the first token to include metadata that is stored using a Merkle tree structure, wherein the metadata includes an expiry date and an amount of license fee associated with the first license.

15. A computer system, comprising:
(a) a processor; and
(b) a non-transitory computer-readable medium having stored thereon instructions that, when executed by the processor, cause the processor to perform the following:
generate and store a first fungible token (FT) associated with a first product, and a second FT associated with a second product;
in response to receiving, from a first client system associated with a first user, a first request to obtain a first license associated with the first product,
select a first blockchain from multiple blockchains accessible by the computer system, wherein the multiple blockchains include at least the first blockchain and a second blockchain; and
based on the first FT, generate and store a first non-fungible token (NFT) on the first blockchain to issue the first license; and
in response to receiving, from a second client system associated with a second user, a second request to obtain a second license associated with the first product or a second product,
select the second blockchain from the multiple blockchains; and
based on the first FT or the second FT, generate and store a second NFT on the second blockchain to issue the second license.

16. The computer system of claim 15, wherein the instructions for selecting the first blockchain cause the processor to:
select the first blockchain based on one or more of the following first features associated with the first blockchain: trust level, performance level and cost.

17. The computer system of claim 15, wherein the instructions for selecting the first blockchain and the second blockchain cause the processor to:
select the first blockchain and the second blockchain from the multiple blockchains that are each implemented using one of the following: layer 1 blockchain technology, layer 2 blockchain technology, private blockchain technology, consortium blockchain technology and cross-chain technology.

18. The computer system of claim 15, wherein the instructions for generating and storing cause the processor to:
prior to receiving the first request, generate and store the first FT on a first license registrar with a first licensor; and
update a first license store associated with a first licensor to indicate that the first FT is available for acquisition.

19. The computer system of claim 18, wherein the instructions further cause the processor to:
prior to receiving the first request, transfer ownership of the first FT from the first licensor to a vendor; and
update a second license store associated with the vendor to indicate that the first FT is available for acquisition.

20. The computer system of claim 15, wherein the instructions for generating and storing the first NFT cause the processor to:
generate and store the first NFT to include metadata that is stored using a Merkle tree structure, wherein the metadata includes an expiry date and an amount of license fee associated with the first license.

21. The computer system of claim 15, wherein the instructions for generating and storing the first NFT cause the processor to:
call or invoke a smart contract function to mint the first NFT on the first blockchain based on the first FT associated with the first product.
